(19) United States
(12) Patent Application Publication
(10) Pub. No.: US 2017/0306744 A1
(43) Pub. Date: Oct. 26, 2017

(54) Downhole Electrode Apparatus, Systems, And Methods

(71) Applicant: Halliburton Energy Services, Inc., Houston, TX (US)

(72) Inventors: Hau Jiun CHEN, Singapore (SG); Yan Wah CHIA, Singapore (SG)

(73) Assignee: Halliburton Energy Services, Inc., Houston, TX (US)

(21) Appl. No.: 15/529,788

(22) PCT Filed: Dec. 14, 2015
(86) PCT No.: PCT/US2015/065569

§ 371 Date: May 25, 2017

Related U.S. Application Data
(60) Provisional application No. 62/106,806, filed on Jan. 23, 2015.

(51) Int. Cl. E21B 47/00; G01V 3/20; E21B 49/00; G01V 3/38; E21B 17/10

(52) U.S. Cl. CPC E21B 47/0002; G01V 3/38; E21B 17/1078; E21B 49/00; G01V 3/20

(57) ABSTRACT

Apparatus, systems, and methods are disclosed. In some embodiments, an apparatus comprises a stabilizer element attached to a downhole tool housing. The stabilizer element includes at least a portion of a surface that is not parallel to a longitudinal axis of the tool housing, and that does not contact a borehole wall during operation. An electrode element is attached to the portion of the surface.

### PRIORITY APPLICATION

This application claims the benefit of priority to U.S. Provisional Application Ser. No. 62/106,806, filed on Jan. 23, 2015 which application is incorporated by reference herein in its entirety.

### BACKGROUND

Understanding the structure and properties of geological formations may reduce the cost of drilling wells for oil and gas exploration. Measurements are typically performed in a borehole (i.e., downhole measurements) in order to attain this understanding. For example, such measurements may identify the composition and distribution of material that surrounds the measurement device downhole. To obtain such measurements, a variety of sensors and mounting configurations may be used. However, direct contact of the sensor with the formation may be detrimental to the structural integrity of the sensor.

### BRIEF DESCRIPTION OF THE DRAWINGS

FIG. 1 is a side view of a drilling assembly, including electrodes attached to stabilizer elements according to various embodiments of the invention.

FIG. 2 provides side and cross-section views of electrodes attached to stabilizer elements according to various embodiments of the invention.

FIG. 3 provides a cross-section view of electrodes attached to a stabilizer element according to various embodiments of the invention.

FIG. 4 illustrates the electric field emanating from a horizontal button electrode element, according to various embodiments of the invention.

FIG. 5 illustrates the electric field emanating from an angled button electrode element, according to various embodiments of the invention.

FIG. 6 illustrates the electric field emanating from an angled focusing electrode element, according to various embodiments of the invention.

FIG. 7 is a frontal view of a focusing electrode element, according to various embodiments of the invention.

FIG. 8 is a frontal view of a focusing electrode element, illustrating mode switching, according to various embodiments of the invention.

FIG. 9 is a side view of a button electrode element, with a fracture approximately perpendicular to the face of the element, according to various embodiments of the invention.

FIG. 10 is a side view of a button electrode element, with a fracture that is not perpendicular to the face of the element, according to various embodiments of the invention.

FIG. 11 is a side view of electrodes mounted to a stabilizer to acquire resistivity data, according to various embodiments of the invention.

FIG. 12 is a block diagram of an electrode tool system according to various embodiments of the invention.

FIG. 13 is a flow diagram illustrating methods of electrode operation, according to various embodiments of the invention.

FIG. 14 depicts an example wireline system, according to various embodiments of the invention.

FIG. 15 depicts an example drilling rig system, according to various embodiments of the invention.

### DETAILED DESCRIPTION

The present disclosure includes embodiments of an angled button electrode element that can be used to facilitate obtaining resistivity values of a formation to assess the presence of hydrocarbons. The electrode elements may be considered to form portions of galvanic tools, where currents are injected from the electrodes into the formation with the current return located at the tool, in the tool string, or at the surface. These tools may operate at a relatively low frequency that varies from a few hertz to a few kilohertz. Resistivity measurements provided by these tools can be used to produce images of various elements surrounding the tool, including borehole walls, cement, and the formation itself.

Various embodiments disclosed herein can improve the ability of galvanic tools to capture high resolution images downhole. High resolution imaging is valuable in identifying a variety of geological attributes such as structural dip, faults and fractures. Furthermore, in unconventional reservoirs, high resolution imaging can be useful to recognize natural and drilling-induced fractures, and may be used to optimize hydraulic fracturing operations.

For micro-resistivity imaging, button electrodes may be used in accordance with one or more embodiments disclosed herein. Stand-off distance is one of the parameters that may influence the measurement performance of this technology, in addition to the outer diameter of the electrode element. Table I depicts vertical resolution (also known as axial resolution or resolution along the tool axis) as a function of button electrode diameter (with additional focus electrode at the same potential) and stand-off distance separated by oil based mud (OBM). Typically, OBM degrades vertical resolution. The stand-off at 0 in (0 mm) shows available resolution without the mud layer.

TABLE I

| | Button Electrode Diameter | | |
|---|---|---|---|
| Stand-off | 0.0787 in (2 mm) | 0.2362 in (6 mm) | 1 in (25.4 mm) |
| 0 in (0 mm) | 0.07874 | 0.2362 | 0.98 |
| 0.1 in (2.54 mm) | 0.3346 | 0.2913 | 1.10 |
| 0.2 in (5.08 mm) | Not Detectable | 0.3400 | 1.60 |

Table I illustrates by way of example that high resolution imaging can be obtained when the smallest feasible button size is located as close as possible to the borehole wall. Thus, attempts have been made to use button electrodes in contact (wireline) or proximity (drilling) with the borehole wall. Although in theory, providing the sensing element at the wall reduces stand-off and therefore increases resolution, it does create an additional hazard. For instance, the useful operational lifetime of an electrode may be substantially reduced, due to erosion and corrosion facilitated by constant contact with the borehole wall. Electrode failures downhole are to be avoided when possible.

One solution might be to include electrodes on a raised structure which is located slightly below the stabilizer blade. Typically, such structures are protected by two stabilizers, one above and one below. However, using additional stabilizers on a drill string may not be desirable, since friction is increased, and the rate of penetration is reduced. Similarly, installing electrodes within the groove of a stabilizer will not permit high resolution images to be captured, as the distance to the borehole wall is increased. A non-tilted electrode on a protruded structure or rib results in comparable challenges and disadvantages. Therefore, the various embodiments described herein operate with electrodes attached directly to stabilizer elements, on tilted element surfaces that refrain from contacting the borehole wall.

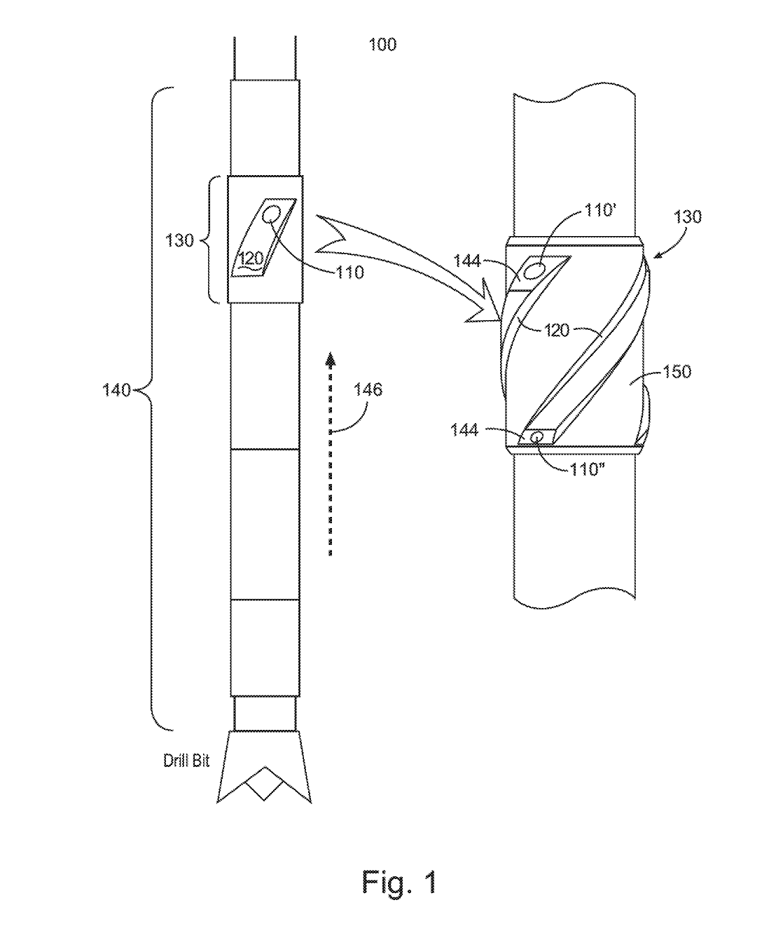

FIG. 1 is a side view of a drilling assembly 100, including electrodes 110 attached to corresponding stabilizer elements 120 according to various embodiments of the invention. Here, a stabilizer 130 forms part of a bottom hole assembly (BHA) 140. Whether the stabilizer 130 is of the spiral stabilizer type (shown in the enlarged view of the stabilizer 130), or a vertically protruding blade stabilizer type (not shown), there will be sloped surfaces 144 on the ends where the blade of the stabilizer element 120 meets the collar 150. In most embodiments, as illustrated in FIG. 1, one or more of the electrodes 110 is installed on the sloped or tilted portion of the respective stabilizer element 120 (e.g., on the surface 144). The shape and size of the stabilizer element 120 can be customized accordingly to permit this positioning of the electrode 110 while at the same time not hindering the function of stabilizing the BHA 140 and permitting mud 146 to flow through or around the BHA 140.

Imaging electrodes 110 can thus be located on the upper (downstream, in relation to the mud 146 flow) sloped end of the stabilizer element surface 144 (e.g., stabilizer blade surface). This location is useful, since it is protected from mud 146 flow and debris. Nonetheless, installation can be on either the upper (e.g., downstream, as shown for electrode 110′) or lower (e.g., upstream, as shown for electrode 110″) sloped end surface, or on each end of the stabilizer element, as will be shown in other figures herein.

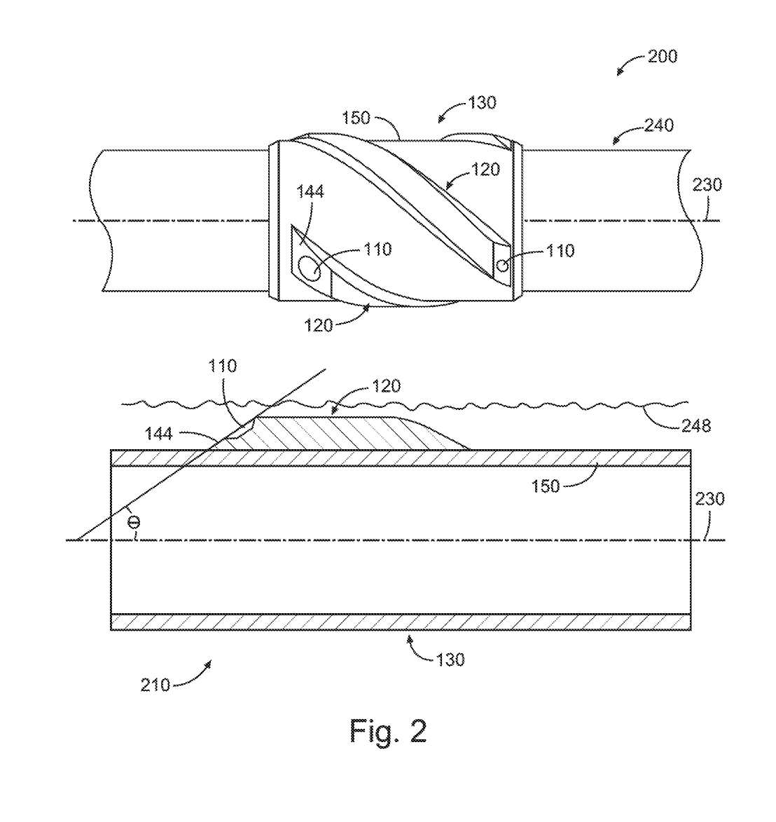

FIG. 2 provides side and cross-section views 200, 210 of electrodes 110 attached to stabilizer elements 120 according to various embodiments of the invention. Here the cross-section view 210 of the stabilizer 130 clearly illustrates the location of the electrode 110 on the surface 144, that forms a non-parallel angle θ with respect to the longitudinal axis 230 of the tool 240. An advantage of this arrangement for many embodiments is that the electrode 110 can be located close to the borehole wall 248 during operation, without touching it. The result is that a smaller diameter electrode can be installed, enabling the production of higher resolution images.

It may be beneficial to mention here that micro-resistivity imaging is used in wireline tools, which have the advantage of using button electrodes very close to the borehole wall 248, since the environment is more forgiving (e.g., there is no drilling while imaging). Even so, some embodiments of the invention may be useful in the wireline environment as well, lending a ruggedness and reliability that has not be heretofore available.

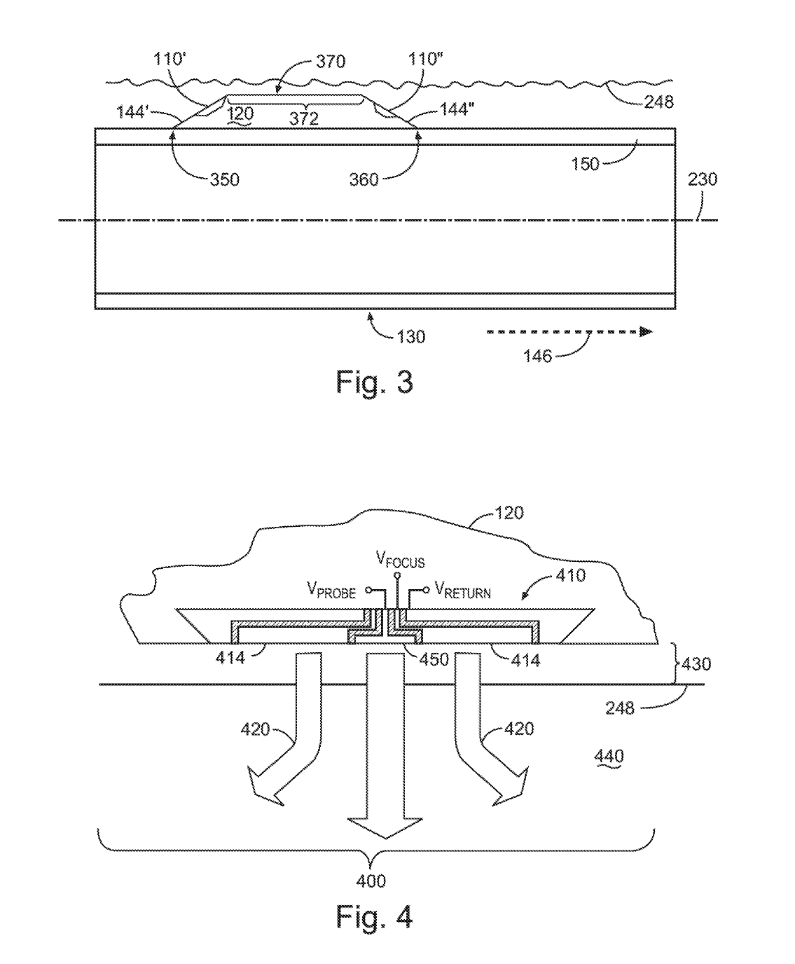

FIG. 3 provides a cross-section view of electrodes 110 attached to a stabilizer element 120 according to various embodiments of the invention. Here the electrodes 110 are of different sizes, with electrode 110′ mounted to surface 144′ of the stabilizer element 120 having a larger diameter than the electrode 110″ mounted to the surface 144″ of the stabilizer element 120. Thus, the surfaces 144′, 144″ are disposed on opposing ends (e.g., a proximal, upstream end 350 and a distal, downstream end 360 of a stabilizer element 120. In some embodiments, electrodes 110 of different diameters or other dimensions are disposed on the tilted surfaces 144 of two different stabilizer elements 120, instead of on opposing ends of a single stabilizer element 120.

Providing electrodes 110 on both ends 350, 360 of a stabilizer element 120 provides the opportunity to capture two different images of similar or differing resolution during drilling or wiping operations. These images can then be combined to produce a higher resolution image. Combining images to produce high resolution images is known to those of ordinary skill in the art, and those that desire further information can refer to the published literature.

Thus, in some embodiments, an image of the same formation element, for example, can be developed using two different resolutions while the tool rotates: a high resolution image and a low resolution image. Azimuthal binning of sectors can be used to successfully reconstruction the acquired image data to produce a visible image.

Installing two electrodes on the same stabilizer element, or on different elements at the same longitudinal elevation, can provide redundancy in the event an electrode no longer operates properly (i.e., the electrode is broken). Doing so also provides the ability to combine or overlap two images (e.g., the high and low resolution images) to produce an improved high resolution image. Further, doing so can improve the capture of information related to fractures present at low angles to the borehole.

FIG. 4 illustrates the electric field 400 emanating from a horizontal button electrode element 410, according to various embodiments of the invention. This figure, which shows the button electrode element 410 installed in the stabilizer blade element 120 (which is electrically coupled to the tool body), also demonstrates the purpose of a focus electrode 414 (coupled to V_{FOCUS}), which helps isolate the measurement electrode 450 (coupled to V_{PROBE}) from non-uniformities in the electrical field 400, causing the electrical field lines 420 emanating from the measurement electrode to pass through the mud gap 430 and enter the formation 440 at right angles to the surface of the measurement electrode 450 facing the borehole wall. V_{FOCUS} is substantially equal to V_{PROBE} for focusing the electric currents and reducing dispersion of current flow with distance from the borehole wall. The dispersion of current flow caused by the mud gap 430 is thus strongly limited in the region near the measurement electrode 450, thereby preventing a loss of resolution. The element 410 is one example of an electrode 110 shown in FIG. 1. There are many other examples.

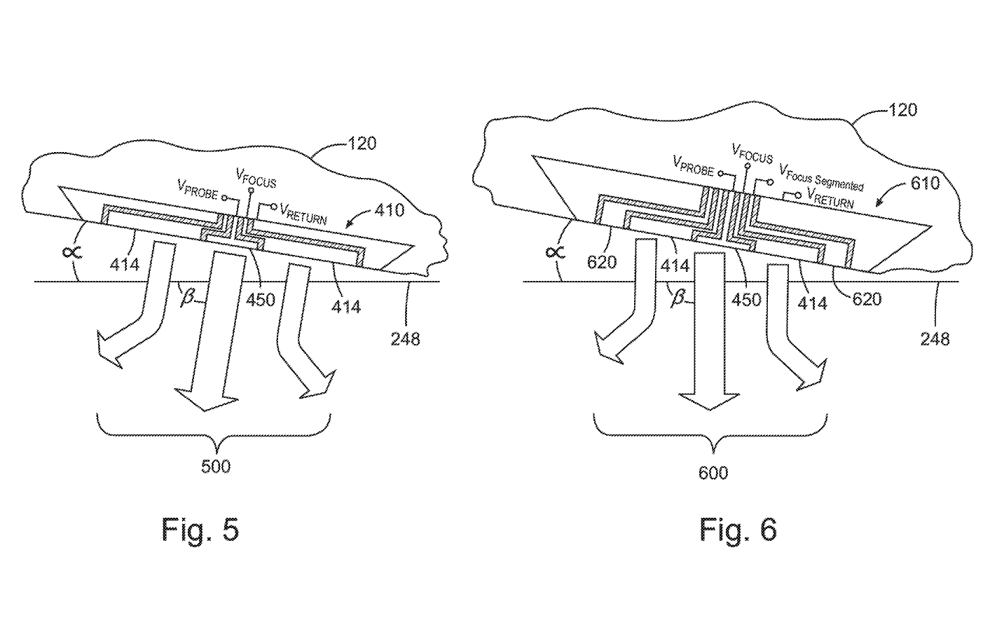

FIG. 5 illustrates the electric field 500 emanating from an angled button electrode element 410, according to various embodiments of the invention. Here the tilted electrode surface forms an angle α with the borehole wall, and the field 500 enters the formation 440 through the borehole wall at a non-perpendicular angle β. Here a single circular focus electrode (i.e., a full focus ring) 414 is used.

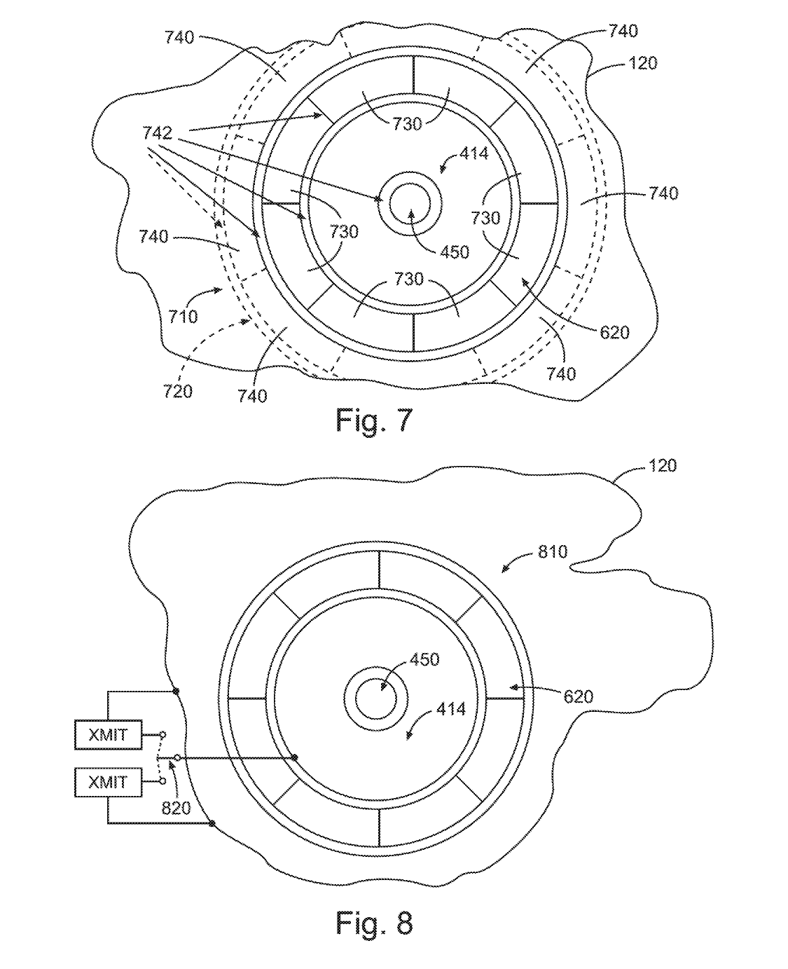

FIG. 6 illustrates the electric field 600 emanating from an angled focusing electrode element 610, according to various embodiments of the invention. In this case, there is an inner primary focus electrode 414, surrounded by an outer, segmented secondary focus electrode 620. Note the difference in the direction with respect to the borehole wall (i.e., the angle β) of the electric field 500 in FIG. 5, where a single focus electrode 414 is used, and the direction of the electric field 600 in FIG. 6, where two concentric focus electrodes 414, 620 are used. In FIG. 5, the angle β tends toward zero degrees as the angle α increases towards 90 degrees), while in FIG. 6, the angle β tends toward 90 degrees (i.e., substantially perpendicular to the borehole wall). The values of V_{FOCUS} and V_{FOCUS Segmented} applied to one or more segments (see segments 730 in FIG. 7) should be substantially equal to V_{PROBE} for focusing and tilting the electric currents. But, as will be explained in more detail below, for each segment, V_{FOCUS} Segmented is not necessarily the same. The element 610 is one example of an electrode 110 shown in FIG. 1. There are many other examples.

FIG. 7 is a frontal view of a focusing electrode element 710, according to various embodiments of the invention. Here the central measurement electrode 450, the primary focus electrode 414, and the (first) segmented secondary focus electrode 620 can be seen. In some embodiments, a (second) segmented secondary focus electrode 720, with segments 740, surrounds the first segmented secondary focus electrode 620, having segments 730. The central measurement electrode 450 and the primary focus electrode 144 are separated by insulating material 742, typically of a dielectric type. Similarly, the segmented electrode 620 is electrically isolated from the primary focus electrode 144 by insulating material 742, again of the dielectric type. The material used to insulate electrodes from each other and a tool body are well known to those of ordinary skill in the art.

Each segment 730, 740 is individually controlled by electronic circuit which is not shown in this figure. The adjoining boundaries of the segments 730, 740 in the secondary focus electrodes 620, 720 may be aligned (not shown), or non-aligned, as shown in FIG. 7. The number of segments 730, 740 may be more or less than what is shown in FIG. 7, depending on the amount of electric field control desired for a particular embodiment. In some embodiments, the voltage applied to each segment 730, 740 can be independently varied and may be shut off completely if desired.

By controlling the voltage (potential ΔV) that is applied to segments 730, 740 within the focus electrodes 620, 720, the emanating electric field can be focused, so as to be concentrated in the immediate vicinity of the central measurement electrode 450. V_{FOCUS} and V_{FOCUS Segmented} of one more segments should be substantially equal to V_{PROBE} for focusing and tilting the electric currents. But, in some embodiments, V_{FOCUS Segmented} is not necessarily the same for each segment. For example, voltage can be applied to the primary focus electrode 414 to provide broad focusing. Fine tuning of the electric field application can be accomplished by the application of voltage to the segmented second focus electrode(s) 620, 720. The electric field emanating from the focusing electrode element 610, 710 can be swept using sequenced application of voltage to the various segments of the focus electrode element.

FIG. 8 is a frontal view of a focusing electrode element 810, illustrating mode switching, according to various embodiments of the invention. Here it can be seen that the primary focus electrode 414 can also be used as a larger measurement electrode by enabling an electrical switch to the receiver XCVR instead of a voltage supply XMIT. In this mode of operation, the voltage V_{FOCUS} is not applied for transmission, but instead the electrode 414 operates in a reception mode. The larger measurement electrode provides longer distance. The segmented focus electrode 620 still maintains its focusing mode (transmit) in this operation. Changing the operational mode of the primary focus electrode 414 in essence functions to enlarge the size of the central measurement electrode, to enable imaging operation over a greater distance into the formation. The elements 710, 810 are examples of an electrode 110 shown in FIG. 1. There are many other examples.

Referring now to FIGS. 7 and 8, for each measurement obtained from the electrode element 710, 810, a tool or geometric constant will be derived from the voltage and current for a set of homogeneous formation resistivity measurements at zero standoff distance from the borehole wall. This information can be obtained from computer electromagnetic simulation, and verified by laboratory measurements. The equation for Resistivity (ρ in ohm·meters) can be expressed as: ρ=K*R, where; K is the tool constant or geometric factor (in meters), which depends on the position, size, and type of electrode; and R is the resistance (in ohms). During calibration operations, ρ and R are known from simulation and via initial measurement in the laboratory, and used to compute K. Afterward, during operation, the measured resistance R′ is obtained from the measured voltage V′ and measured current I′. Thus, the final measured apparent resistivity ρ′ is obtained from the equation using K and R′. When measurements of different resolution are obtained, more than one tool constants is also obtained.

For example, one tool constant may be obtained with respect to the central measurement electrode 450 and the focus electrodes 414, 620 with the tool body 120. Another tool constant may be obtained for the larger measurement electrode (primary focus electrode 414 electrically switched to operate in reception mode) and the segmented secondary focus electrode 620 with the tool body 120. The measured apparent resistivity ρ′ associated with each tool constant, along with the measured voltage V′ and current I′ could be derived from formation, or the mud, or the combined effects of the formation and the mud. Additional borehole correction may be used to derive the formation's resistivity if the measured resistivity includes both mud and formation interaction.

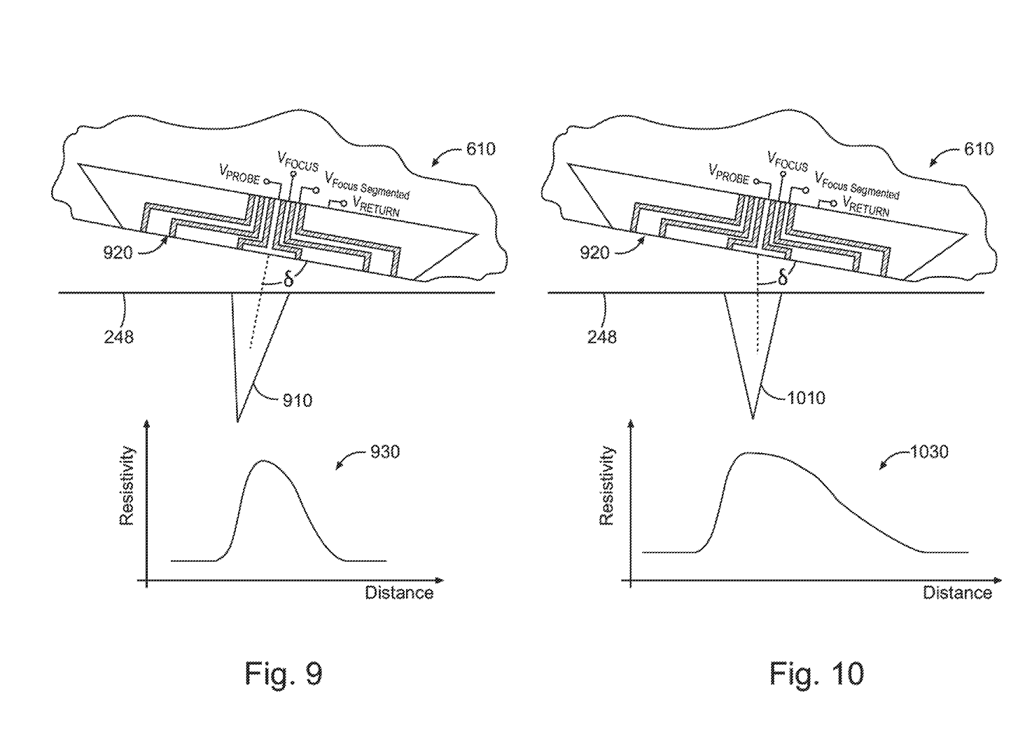

FIG. 9 is a side view of a button electrode element 410, with a fracture 910 approximately perpendicular to the face 920 of the element 410, according to various embodiments of the invention. FIG. 10 is a side view of a button electrode element 410, with a fracture 1010 that is not perpendicular to the face 920 of the element 410, according to various embodiments of the invention. Thus, in FIG. 9, the angle δ is approximately 90 degrees, whereas in FIG. 10, the angle δ is acute, or obtuse, and not approximately 90 degrees. This angle δ affects the resolution that is available, since the resistivity is greater over a greater distance into the borehole wall with the arrangement shown in FIG. 10, than it is for the arrangement shown in FIG. 9, as can be seen by reviewing the graphs 930, 1030 in FIGS. 9 and 10, respectively.

There are two effects to consider: the fracture angle δ, and the mud gradient (i.e., as current travels through mud of differing depth). The fracture angle can be derived mathematically as the angle of tilt δ for the electrode is known and fixed as a result of the electrode being located on the sloping end of a stabilizer element. Compensation for the effect due to the mud gradient can be achieved with the use of a mud sensor (not shown in FIGS. 9-10) as is known to those of ordinary skill in the art.

As is known to those of ordinary skill in the art, and made explicit in the document “Analysis of Fracture Orientation Data from Boreholes” published by the United States Department of Geology and Geophysics, University of Hawaii in 1999, boreholes can introduce a pronounced observational bias into the data, with fractures at low angles to the borehole being under-represented. Thus, it is useful to properly account for borehole bias when borehole fracture data is used to evaluate the geology, mechanics, or hydraulics of a subsurface rock mass.

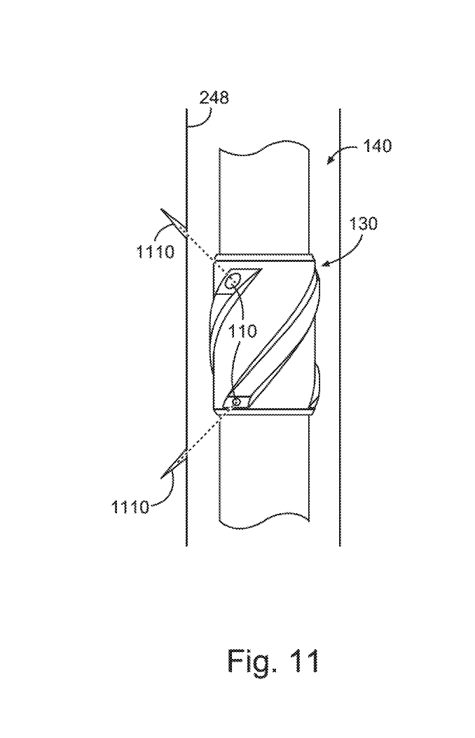

FIG. 11 is a side view of electrodes 110 mounted to a stabilizer 130 to acquire resistivity data, according to various embodiments of the invention. In this figure, tilted button electrodes 110 attached to the sloping ends of a stabilizer 130 on the BHA 140 may potentially provide a more accurate representation of the depth and location of the fractures 1110. An optional, conventional “non-tilted” button electrode may be included on the BHA, of which the stabilizer 130 forms a part. Thus, still further embodiments may be realized.

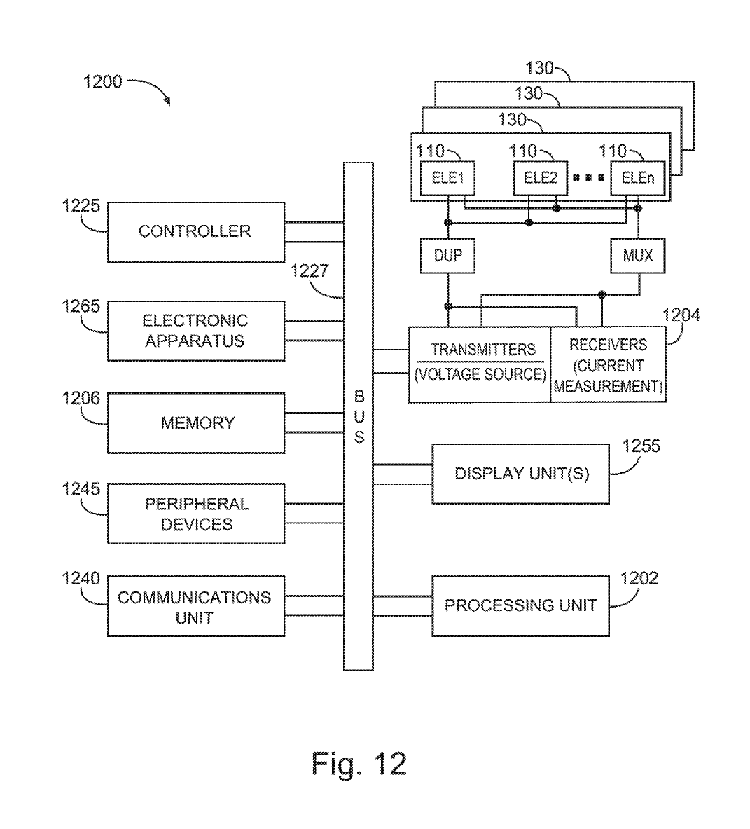

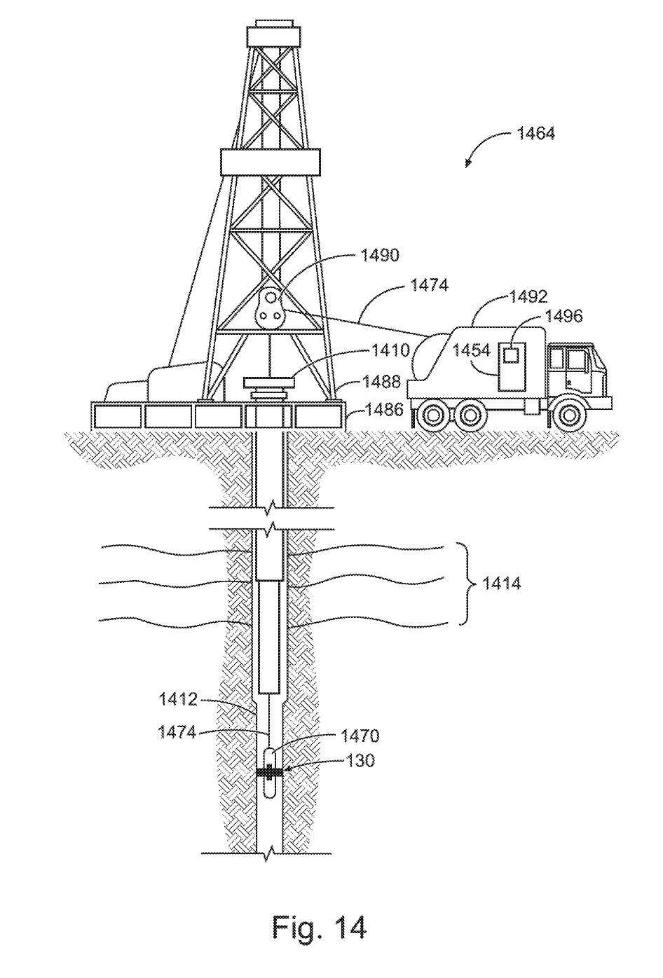

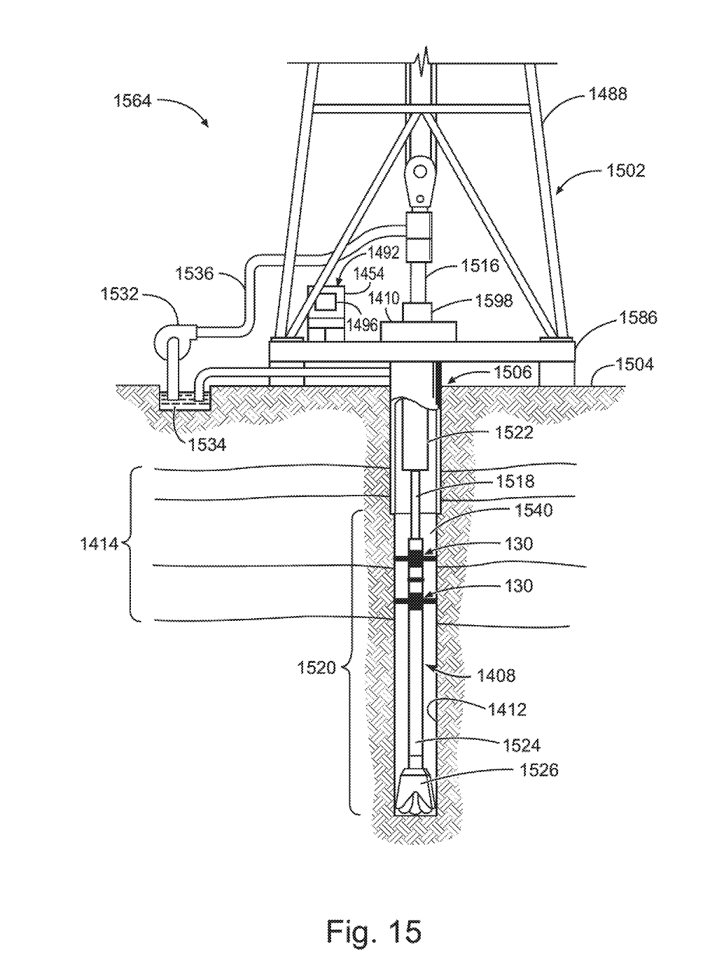

For example, FIG. 12 is a block diagram of an electrode tool system 1200 according to various embodiments of the invention. Referring now to FIGS. 1-11 it can be seen that the system 1200 is closely aligned with the structure and function of the apparatus (in the form of stabilizer 130) shown in the figures. The processing unit 1202 can couple to the electrodes 110 in the stabilizer 130 to obtain resistivity measurements. In some embodiments, a galvanic tool system 1200 comprises one or more of the stabilizers 130, perhaps in the form of a housing. The housing might take the form of a wireline tool body, or a downhole tool as described in more detail below with reference to FIGS. 14 and 15. The processing unit 1202 may be part of a surface workstation or attached to a downhole tool housing. In some embodiments, the processing unit 1202 is packaged within the BHA 140.

The system 1200 can include a controller 1225, other electronic apparatus 1265, and a communications unit 1240. The controller 1225 and the processing unit 1202 can be fabricated to operate one or more components of the stabilizer 130 to acquire measurement data, such as resistivity measurements. In some embodiments, the controller 1225 may operate to control the simultaneous application of voltage (e.g., via transmitters/voltage sources and receivers/current measurement devices 1204), or measurement of a set of currents, at the same frequency, or at different frequencies.

Electronic apparatus 1265 (e.g., voltage sources, current sources, electrodes, receivers, antennas, etc.) can be used in conjunction with the controller 1225 to perform tasks associated with taking resistivity measurements downhole. The communications unit 1240 can include downhole communications in a drilling operation. Such downhole communications can include a telemetry system.

The system 1200 can also include a bus 1227 to provide common electrical signal paths between the components of the system 1200. The bus 1227 can include an address bus, a data bus, and a control bus, each independently configured. The bus 1227 can also use common conductive lines for providing one or more of address, data, or control, the use of which can be regulated by the controller 1225.

The bus 1227 can include instrumentality for a communication network. The bus 1227 can be configured such that the components of the system 1200 are distributed. Such distribution can be arranged between downhole components such as the stabilizers 130, and components that can be disposed on the surface of a well. Alternatively, several of these components can be co-located, such as on one or more collars of a drill string or on a wireline structure.

In various embodiments, the system 1200 includes peripheral devices that can include displays 1255, additional storage memory, or other control devices that may operate in conjunction with the controller 1225 or the processing unit 1202. The display 1255 can display data, calculated results, resistivity, and diagnostic information for the system 1200 based on the signals generated according to embodiments described above. The display 1255 can also be used to display one or more resistivity plots.

In an embodiment, the controller 1225 can be fabricated to include one or more processors. The display 1255 can be fabricated or programmed to operate with instructions stored in the processing unit 1202 (for example in the memory 1206) to implement a user interface to manage the operation of the system 1200. This type of user interface can be operated in conjunction with the communications unit 1240 and the bus 1227. Various components of the logging system 1200 can be integrated with a housing such that processing identical to or similar to the methods discussed with respect to various embodiments herein can be performed downhole.

In various embodiments, a non-transitory machine-readable storage device can include instructions stored thereon, which, when performed by a machine, cause the machine to become a customized, particular machine that performs operations comprising one or more activities similar to or identical to those described with respect to the methods and techniques described herein. A machine-readable storage device, herein, is a physical device that stores information (e.g., instructions, data), which when stored, alters the physical structure of the device. Examples of machine-readable storage devices include, but are not limited to, memory 1206 in the form of read only memory (ROM), random access memory (RAM), a magnetic disk storage device, an optical storage device, a flash memory, and other electronic, magnetic, or optical memory devices, including combinations thereof.

The physical structure of stored instructions may thus be operated on by one or more processors such as, for example, the processing unit 1202. Operating on these physical structures can cause the machine to perform operations according to methods described herein. The instructions can include instructions to cause the processing unit 1202 to store associated data or other data in the memory 1206. The memory 1206 can store the results of measurements of formation parameters or parameters of the system 500, to include gain parameters, calibration constants, identification data, etc. The memory 1206 can store a log of resistivity measurements obtained by the system 1200. The memory 1206 therefore may include a database, for example a relational database. Thus, still further embodiments may be realized.

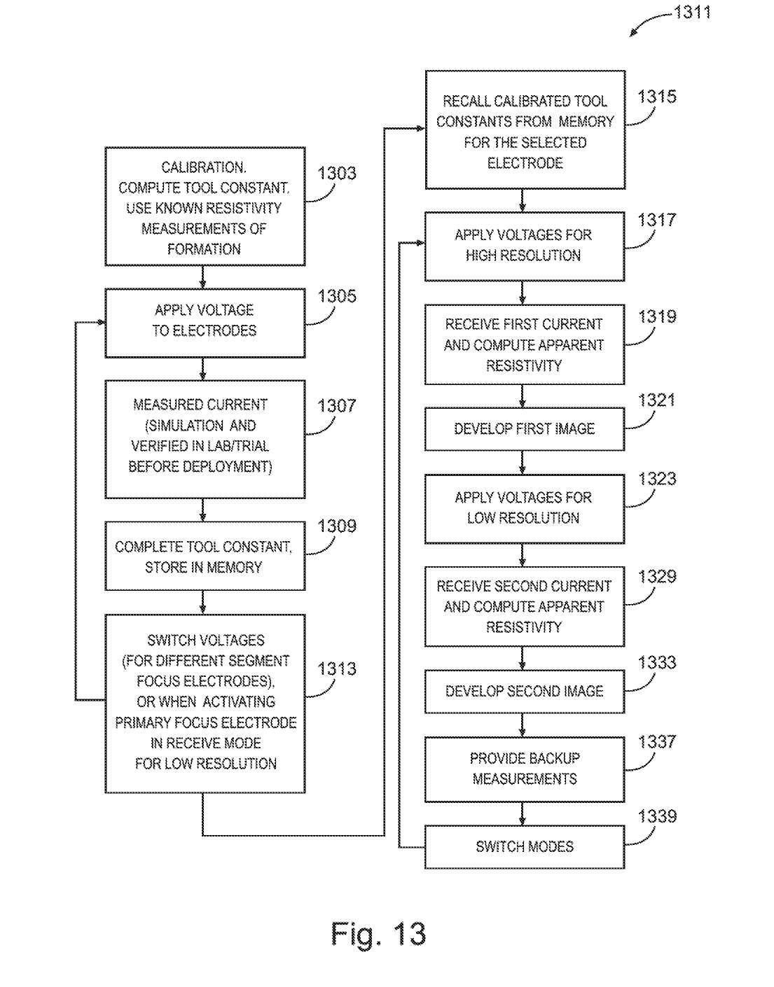

For example, FIG. 13 is a flow diagram illustrating methods 1311 of electrode operation, according to various embodiments of the invention. The methods 1311 described herein are with reference to hardware circuitry, and the operation thereof, including measurements, switching, transmission, and reception, etc. shown in FIGS. 1-12. Some operations of the methods 1311 can be performed in whole or in part by the processing unit 1202 or controller 1225 (see FIG. 12), although many embodiments are not limited thereto.

An initial calibration process to compute and store geometric/tool constant information in memory for selected electrodes is shown in blocks 1303-1313. An accurate tool constant is calculated using an electromagnetic computer simulation, based on numerical methods (e.g., finite element, finite difference, integral equations, etc.) as are known to those of ordinary skill in the art and found in commercially available design tools with selected formation types of known resistivity (e.g., homogeneous formations), and verified with measurements in the laboratory for the appropriate medium. Using the computed tool constant, the apparent resistivity of heterogeneous formation can be computed/extrapolated over the measured current and applied voltage in field operations (illustrated in blocks 1315-1339).

For example, as is known to those of ordinary skill in the art, one objective of using a resistivity tool may be to measure apparent resistivity using a tool constant. In some embodiments, the tool constant is obtained by implementing a calibration procedure with a known formation type (e.g., homogeneous) and zero standoff distance from the borehole wall. This calibration procedure is performed, and afterward, the various voltages applied, along with currents measured at the electrode, for several values of the known resistivity of the homogeneous formation, are stored in memory. This portion of the process is shown as part of the methods 1311, at blocks 1303-1309.

In some embodiments, an electromagnetic computer simulation is implemented to compute the tool constant, which is verified with measurements in the laboratory or a test well. Thus, whenever operating modes are switched, to use different combinations of voltages for focus electrodes, the appropriate tool constant is recalled from the memory at block 1315 to compute the apparent resistivity using the tool constant for the selected electrode.

In the field, during downhole operations, the resistivity of the formation is unknown (e.g., the makeup of the formation is likely heterogeneous and a mud layer is often present in the borehole, etc.) and will change according to the environment. As a result, the measured current will change for a set of measured voltages and hence apparent resistivity of the formation will change. Nevertheless, the tool constant K does not change for a given set of applied voltage and electrodes.

To support multiple resolution imaging, corresponding multiple tool constants may thus be acquired. Hence, various combination of focus electrodes are selected in the calibration process shown, in accordance with various embodiments.

Thus, in some embodiments, the methods 1311 include recalling calibrated tool constants for a selected electrode from memory at block 1315; applying a voltage to an electrode element at block 1317, to inject a current into the borehole wall; and receiving the current at block 1319, using one or more electrode elements configured as described in the apparatus shown in FIGS. 1-12. In some embodiments, the portion of the electrode element used for reception is selected to provide relatively high resolution measurement data (e.g., a smaller diameter electrode element, rather than a larger one). In some embodiments, the portion of the electrode element used for reception is selected to provide relatively low resolution measurement data (e.g., a larger electrode element, rather than a smaller one).

In some embodiments, a method 1311 begins at block 1317 (or continues on to block 1317 from block 1315), with applying a voltage to a first electrode element to inject a first current into a borehole wall in a geological formation.

In some embodiments, the method 1311 continues on to block 1319 with receiving the first current at a downhole tool housing, wherein a stabilizer element is attached to the downhole tool housing, wherein the stabilizer element includes a first portion of a surface to contact the borehole wall, and a second portion of the surface to refrain from contacting the borehole wall, and wherein the first electrode element is attached to the second portion of the surface. The activity at block 1319 may include calculating an apparent resistivity corresponding to measurement of the first current.

Images of different resolutions may be developed, and afterward, combined or overlapped. Thus, in some embodiments, the method 1311 comprises developing a first image of the borehole wall using measurements of the first current at block 1321. The image may be a relatively high resolution image when the electrode selected for measurement is an electrode with a smaller diameter, rather than one with a larger diameter.

The method may include the application of voltage to multiple electrode elements, or various segments of a single electrode element. A sequenced application of the voltage may thus be employed, using the electrode elements, or segments of those elements, in any selected order, such as using multiple groups of segments, including inner and outer segmented groups that make up a focusing electrode element. Thus, in some embodiments, the activity of block 1323 comprises applying a voltage to a second electrode element to inject a second current into a borehole wall in a geological formation. In some embodiments, the activity at block 1323 comprises selectively applying the voltage to one or more arcuate segments included in the electrode element.

The currents generated by the application of voltage to one portion of the electrode element (e.g., to a central measurement electrode portion of the element) may be received at the tool body, and/or at another portion of the electrode element. Thus, in some embodiments, as a result of applying the voltage to the second electrode element at block 1323, the method 1311 continues on to block 1329 with receiving a second current at a focus electrode (where the voltage of the focus electrode is substantially the same as the voltage at the measurement electrode) portion of the electrode element. The activity at block 1329 may comprise calculating a second value of apparent resistivity, corresponding with measurement by the second element.

The method 1311 may continue on to block 1333 to include developing a second image of the borehole wall using measurements of a second current injected into the borehole wall by applying the voltage to a second electrode element attached to a third portion of the surface, wherein an image resolution of the first image relative to an image resolution of the second image depends on a size relationship between the first electrode element and the second electrode element. Thus, for example, the second image may be a relatively low resolution image when the electrode selected for measurement is an electrode with a larger diameter, rather than one with a smaller diameter.

Some electrodes may be used to acquire redundant data, to back up other electrodes that malfunction. Thus, in some embodiments, the method 1311 may include the activity of imaging the borehole wall using the first current at block 1321, and applying the voltage to a second electrode element attached to a third portion of the surface at block 1323, to provide a backup current measurement value to a measurement of the first current at block 1337.

Portions of a focusing electrode may be cycled between transmission and reception modes of operation, to increase measurement depth capability. Thus, in some embodiments, the method 1311 may include switching between a transmission mode and a reception mode by coupling a voltage generator or a current receiver, respectively, to a primary focus electrode included in the first electrode element at block 1339.

It should be noted that the methods described herein do not have to be executed in the order described, or in any particular order, unless explicitly specified as such. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or inter-process communication techniques, including remote procedure calls. The teachings of various embodiments are not limited to any particular programming language or environment. Thus, other embodiments may be realized.

For example, FIG. 14 depicts an example wireline system 1464, according to various embodiments of the invention. FIG. 15 depicts an example drilling rig system 1564, according to various embodiments of the invention. Either of the systems in FIG. 14 and FIG. 15 are operable to control an apparatus, such as a stabilizer 130 (and the electrodes 110 attached thereto) and/or system 1200 to conduct measurements in a wellbore. Thus, the systems 1464, 1564 may comprise portions of a wireline logging tool body 1470 as part of a wireline logging operation, or of a downhole tool 1024 (e.g., a drilling operations tool) as part of a downhole drilling operation.

Returning now to FIG. 14, a well during wireline logging operations can be seen. In this case, a drilling platform 1486 is equipped with a derrick 1488 that supports a hoist 1490.

Drilling oil and gas wells is commonly carried out using a string of drill pipes connected together so as to form a drilling string that is lowered through a rotary table 1410 into a wellbore or borehole 1412. Here it is assumed that the drilling string has been temporarily removed from the borehole 1412 to allow a wireline logging tool body 1470, such as a probe or sonde, to be lowered by wireline or logging cable 1474 into the borehole 1412. Typically, the wireline logging tool body 1470 is lowered to the bottom of the region of interest and subsequently pulled upward at a substantially constant speed.

During the upward trip, at a series of depths the instruments (e.g., the electrodes 110 attached to a stabilizer 130 or coupled to a system 1200 shown in FIGS. 1 and 12) included in the tool body 1470 may be used to perform measurements on the subsurface geological formations adjacent the borehole 1412 (and the tool body 1470, which can serve as a housing for various electrodes and antennas). The measurement data can be communicated to a surface logging facility 1492 for storage, processing, and analysis. The logging facility 1492 may be provided with electronic equipment for various types of signal processing, which may be implemented by any one or more of the components of resistivity measurement apparatus, including stabilizers 130, and systems 1200. Similar formation evaluation data may be gathered and analyzed during drilling operations (e.g., during LWD operations, and by extension, sampling while drilling).

In some embodiments, the tool body 1470 comprises a resistivity measurement apparatus, such as a stabilizer 130 and/or system 1200 for obtaining and analyzing resistivity measurements in a subterranean formation through a borehole 1412. The tool is suspended in the wellbore by a wireline cable 1474 that connects the tool to a surface control unit (e.g., comprising a workstation 1454, which can also include a display). The tool may be deployed in the borehole 1412 on coiled tubing, jointed drill pipe, hard wired drill pipe, or any other suitable deployment technique.

Turning now to FIG. 15, it can be seen how a system 1564 may also form a portion of a drilling rig 1502 located at the surface 1504 of a well 1506. The drilling rig 1502 may provide support for a drill string 1508. The drill string 1508 may operate to penetrate the rotary table 1410 for drilling the borehole 1412 through the subsurface formations 1414. The drill string 1508 may include a Kelly 1516, drill pipe 1518, and a bottom hole assembly 1520, perhaps located at the lower portion of the drill pipe 1518.

The bottom hole assembly 1520 may include drill collars 1522, a downhole tool 1524, and a drill bit 1526. The drill bit 1526 may operate to create the borehole 1412 by penetrating the surface 1504 and the subsurface formations 1514. The downhole tool 1524 may comprise any of a number of different types of tools including MWD tools, LWD tools, and others.

During drilling operations, the drill string 1508 (perhaps including the Kelly 1516, the drill pipe 1518, and the bottom hole assembly 1520) may be rotated by the rotary table 1410. Although not shown, in addition to, or alternatively, the bottom hole assembly 1520 may also be rotated by a motor (e.g., a mud motor) that is located downhole. The drill collars 1522 may be used to add weight to the drill bit 1526. The drill collars 1522 may also operate to stiffen the bottom hole assembly 1520, allowing the bottom hole assembly 1520 to transfer the added weight to the drill bit 1526, and in turn, to assist the drill bit 1526 in penetrating the surface 1504 and subsurface formations 1514.

During drilling operations, a mud pump 1532 may pump drilling fluid (sometimes known by those of ordinary skill in the art as “drilling mud”) from a mud pit 1534 through a hose 1536 into the drill pipe 1518 and down to the drill bit 1526. The drilling fluid can flow out from the drill bit 1526 and be returned to the surface 1504 through an annular area 1540 between the drill pipe 1518 and the sides of the borehole 1412. The drilling fluid may then be returned to the mud pit 1534, where such fluid is filtered. In some embodiments, the drilling fluid can be used to cool the drill bit 1526, as well as to provide lubrication for the drill bit 1526 during drilling operations. Additionally, the drilling fluid may be used to remove subsurface formation cuttings created by operating the drill bit 1526.

Thus, it may be seen that in some embodiments, the systems 1464, 1564 may include a drill collar 1522, a downhole tool 1524, and/or a wireline logging tool body 1470 to house one or more stabilizers 130, similar to or identical to the stabilizers 130 described above and illustrated in various figures. Components of the system 1200 in FIG. 12 may also be attached to or housed by the tool 1524 or the tool body 1470, to be constructed and operated as described previously.

Thus, for the purposes of this document, the term “housing” may include any one or more of a drill collar 1522, a downhole tool 1524, or a wireline logging tool body 1470, all having an outer wall that is shared among a number of components. Thus, a housing can be used to enclose or attach to magnetometers, sensors, electrodes, fluid sampling devices, pressure measurement devices, antennae, transmitters, receivers, acquisition and processing logic, and data acquisition systems. The tool 1524 may comprise a downhole tool, such as an LWD tool or MWD tool. In the case of LWD or MWD tools the pads can be fixed in relation to the formation while the center mandrel rotates with the drilling operation. The pads can also be extended only when the rotation stops, to make measurements as desired. The wireline tool body 1470 may comprise a wireline logging tool, including a probe or sonde, for example, coupled to a logging cable 1474. Many embodiments may thus be realized.

For example, referring now to FIGS. 1-15, it can be seen that an apparatus may comprise a tool housing (e.g., drill collar 1522, a downhole tool 1524, or a wireline logging tool body 1470, among others) attached to a stabilizer 130, and one or more electrode elements 110 attached to a surface 144 of the stabilizer 130 that that is non-parallel to the longitudinal tool axis 230, and does not contact the borehole wall when the stabilizer 130 is operating.

For the purposes of this document, a “stabilizer element” 120 is an element that may be attached to a drill string, perhaps forming part of a collar, to stabilize (e.g., centralize) the position of the string within a borehole. A stabilizer element 120 may also be used in conjunction with a wireline tool, such as a sonde, to stabilize (e.g., centralize) the position of the wireline tool within the well bore. A stabilizer 130 mounted to a BHA may include several stabilizer elements 120, such as spiral blades, straight blades, etc.

Thus, in some embodiments, and apparatus comprises a downhole tool housing (e.g., drill collar 1522, a downhole tool 1524, or a wireline logging tool body 1470, among others) and a first stabilizer element 120 attached to the downhole tool housing. The first stabilizer element 120 having at least a first portion 144′ of a surface that is not parallel to a longitudinal axis 230 of the tool housing, and that does not contact a borehole wall during operation. The apparatus further comprises a first electrode element 110 attached to the first portion 144′ of the surface. As seen in FIG. 3, the first electrode element 110′ attached to a first portion 144′ of a surface 370 is located at a first lesser radial distance from the longitudinal axis 230 than a major portion 372 of the surface 370.

A second electrode element can be added to the stabilizer element. Thus, in some embodiments, the apparatus further comprises a second electrode element 110″ attached to a second portion 144″ of the surface of the first stabilizer element 120, the second portion 144″ not parallel to the longitudinal axis 230 or to the first portion 144′, and not contacting the borehole wall during operation of the stabilizer element 120. That is, the second electrode element 110″ is located at a second lesser radial distance from the longitudinal axis 230 then the major portion 372 of the surface 370.

As can be seen most easily in FIG. 3, some stabilizer blades clearly have three portions: the major part that contacts the wall (a major portion 372), and minor portions (surfaces 144′, 144″) that do not. Thus, in the example of FIG. 3, the first portion 144′ and the second portion 144″ of the surface each form a reflex angle with a major portion 372 of the surface 370. That is, the surface 370 of the stabilizer element 120 in FIG. 3 is a continuum formed by the first portion 144′, followed by the major portion 372, followed by the second portion 144″. In most embodiments, the electrodes 110 are located at a lesser radial distance from the longitudinal axis 230 than the major portion 372 of the surface that contacts the borehole wall 248, as is clearly shown in FIG. 3, so that the electrodes 110 do not contact the borehole wall 248 during drilling operations.

The electrode elements can be disposed at different elevations along the tool housing. Thus, in some embodiments, the first electrode element 110′ is disposed at a different elevation along the tool housing than an elevation at which the second electrode element 110″ is disposed along the tool housing.

The electrode elements may be disposed at opposing ends of the stabilizer element. Thus, in some embodiments, the first portion 144′ of the surface comprises a proximal portion of the surface, and wherein the second portion 144″ of the surface comprises a distal portion of the surface.

The two electrode elements may be of different sizes. Thus, in some embodiments the first and second electrode elements 110′, 110″ have different outer diameter measurements.

Electrode elements may be of different types, such as button electrode elements or focusing electrode elements. Thus, in some embodiments, the first electrode element 110 is one of a button electrode element (e.g., element 410) or a focusing electrode element (e.g., element 710).

The focusing electrode element type may be constructed in a manner that includes three major parts: the center, and two focus portions that surround the center. Thus, in some embodiments, the focusing electrode element 710 comprises a central measurement electrode 450, a primary focus electrode 414 (where the voltage of the focusing electrode is substantially the same as the voltage at the measurement electrode), and a first segmented secondary focus electrode 620 (where the voltage of the focus electrode is substantially the same as the voltage at the measurement electrode). In some embodiments, a second segmented secondary focus electrode 720 (where the voltage of the focus electrode is substantially the same as the voltage at the measurement electrode) is disposed to surround the first segmented secondary focus electrode 620 (where the voltage of the focus electrode is substantially the same as the voltage at the measurement electrode).

The focusing electrode element may have a portion that can operate in transmission or reception mode, according to the state of switches that are coupled to the focusing electrode element. Thus, in some embodiments, a switching element 820 is included to selectively enable a transmission mode or a reception mode for the primary focus electrode 414.

The stabilizer element may be of different types, including a blade type, or a spiral type. Thus, in some elements, the first stabilizer element 120 comprises one of a vertically-protruding blade stabilizer element (e.g., element 120 in FIG. 3) or a spiral stabilizer element (e.g., element 120 in FIG. 2).

The apparatus may include multiple stabilizer elements, each with one or more electrode elements. Thus, in some embodiments, the apparatus comprises a second stabilizer element 120 attached to the downhole tool housing, the second stabilizer element having a first portion of a second surface to contact the borehole wall, and a second portion of the second surface to refrain from contacting the borehole wall; and a second electrode element attached to the second portion of the second surface, wherein the first and second stabilizer elements are disposed at an azimuthal angle of greater than zero degrees from each other around the downhole tool housing. An example of this arrangement is included in FIG. 2, with multiple stabilizer elements 120, attached to multiple electrode elements 110. Still further embodiments may be realized.

For example, a system 1600, 1464, 1564 may comprises a downhole tool housing (e.g., drill collar 1522, a downhole tool 1524, or a wireline logging tool body 1470, among others) and a stabilizer element 120 attached to the downhole tool housing, the stabilizer element 120 having a first portion of a surface (e.g., the major portion 370) to contact a borehole wall, and a second portion (e.g., either or both portions 144′ or 144″) of the surface to refrain from contacting the borehole wall. The system may further comprise an electrode element 110 attached to the second portion of the surface, as well as a controller 1225 to control application of a voltage to a portion of the electrode element 110.

A supply element, such as a power supply, may be coupled to the controller to apply voltage to one or more portions of a focusing electrode. Thus, in some embodiments, the system comprises a supply element (e.g., the transmitters/voltage source 1204) coupled to the controller 1225 to selectively provide the voltage to different segments 730, 740 included in a segmented focus electrode 620, 720 (where the voltage of the focus electrode is substantially the same as the voltage at the measurement electrode) included in the electrode element 710.

The tool housing may form part of a larger assembly, in either wirelines or drilling systems. Thus, in some embodiments, the downhole tool housing comprises one of a wireline tool housing or a drill string tool housing.

A mud sensor may be added to the system to compensate for the mud gradient. Thus, in some embodiments, a mud sensor (e.g., operating as one of the sensors in the electronic apparatus 1265) is included in the system to provide a mud gradient measurement, to compensate for resistivity measurements provided by currents associated with the electrode element.

Any of the above components, for example the stabilizer 130 (and each of its elements 110), the systems 1200, 1464, 1564, and each of their elements, may all be characterized as “modules” herein. Such modules may include hardware circuitry, and/or a processor and/or memory circuits, software program modules and objects, and/or firmware, and combinations thereof, as desired by the architect of the apparatus and systems described herein, and as appropriate for particular implementations of various embodiments. For example, in some embodiments, such modules may be included in an apparatus and/or system operation simulation package, such as a software electrical signal simulation package, an electrode current propagation package, resistivity measurement package, a power usage and distribution simulation package, a power/heat dissipation simulation package, a measured radiation simulation package, and/or a combination of software and hardware used to simulate the operation of various potential embodiments. Many more embodiments may be realized, but have not been explicitly listed here in the interest of brevity.

It should also be understood that the apparatus and systems of various embodiments can be used in applications other than for logging operations, and thus, various embodiments are not to be so limited. The illustrations of the apparatus and systems are intended to provide a general understanding of the structure of various embodiments, and they are not intended to serve as a complete description of all the elements and features of apparatus and systems that might make use of the structures described herein.

In summary, using the apparatus, systems, and methods disclosed herein may operate to provide button electrode(s) located at sloping end(s) of a stabilizer element, which can optionally be included in a BHA that may already contain a conventional non-tilted button electrode. In some embodiments, a single button electrode may be attached to the sloping end of a stabilizer element, away from the drill bit to reduce erosion induced by debris/cuttings and mud flow. In some embodiments, button electrodes may be attached to both sloping ends of a stabilizer element, with each electrode of a different dimension to capture high resolution and a low resolution formation image data. This data can be integrated to produce an enhanced high resolution image either via processing downhole or on the surface computer. In some embodiments, a full ring inner focus electrode and segmented outer focus electrode may be applied to improve control of the generated electric field. One or more segmented focus electrodes capable of performing electric field sweeps can be used to cover a wider image area and/or to improve resolution of the images and/or angle of capture. An effectively larger measurement electrode may be provided by transforming the mode of operation of one of the focus electrodes, to provide longer measurement distances. These advantages can significantly enhance the value of the services provided by an operation/exploration company, helping to reduce operational costs and increase customer satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a downhole tool housing;
a first stabilizer element attached to the downhole tool housing, the first stabilizer element having at least a first portion of a surface that is not parallel to a longitudinal axis of the tool housing; and
a first electrode element attached to the first portion of the surface, the first electrode element located at a first lesser radial distance from the longitudinal axis than a major portion of the surface.

2. The apparatus of claim 1, further comprising:
a second electrode element attached to a second portion of the surface of the first stabilizer element, the second portion not parallel to the longitudinal axis or to the first portion, and located at a second lesser radial distance from the longitudinal axis then the major portion of the surface.

3. The apparatus of claim 2, wherein the first portion and the second portion of the surface each form a reflex angle with the major portion of the surface.

4. The apparatus of claim 2, wherein the first electrode element is disposed at a different elevation along the tool housing than an elevation at which the second electrode element is disposed along the tool housing.

5. The apparatus of claim 2, wherein the first portion of the surface comprises a proximal portion of the surface, and wherein the second portion of the surface comprises a distal portion of the surface.

6. The apparatus of claim 2, wherein the first and second electrode elements have different outer diameter measurements.

7. The apparatus of claim 1, wherein the first electrode element is one of a button electrode element or a focusing electrode element.

8. The apparatus of claim 7, wherein the focusing electrode element comprises a central measurement electrode, a primary focus electrode, and a first segmented secondary focus electrode.

9. The apparatus of claim 8, wherein the housing is electrically coupled to serve as a return electrode for a conductive surface (e.g., the stabilizer element) that surrounds the secondary focus electrode.

10. The apparatus of claim 8, further comprising:
a second segmented secondary focus electrode, surrounding the first segmented secondary focus electrode.

11. The apparatus of claim 8, further comprising:
a switching element to selectively enable a transmission mode or a reception mode for the primary focus electrode.

12. The apparatus of claim 1, wherein the first stabilizer element comprises one of a vertically-protruding blade stabilizer element or a spiral stabilizer element.

13. The apparatus of claim 1, further comprising:
a second stabilizer element attached to the downhole tool housing, the second stabilizer element having a first portion of a second surface to contact the borehole wall, and a second portion of the second surface to refrain from contacting the borehole wall; and
a second electrode element attached to the second portion of the second surface, the second electrode element located at a lesser radial distance from the longitudinal axis of the downhole tool housing than a major portion of the second surface, wherein the first and second stabilizer elements are disposed at an azimuthal angle of greater than zero degrees from each other around the downhole tool housing.

14. A system, comprising:
a downhole tool housing;
a stabilizer element attached to the downhole tool housing, the stabilizer element having a first portion of a surface to contact a borehole wall, and a second portion of the surface to refrain from contacting the borehole wall;
an electrode element attached to the second portion of the surface, the electrode element located at a lesser radial distance from a longitudinal axis of the downhole tool housing than a major portion of the surface; and
a controller to control application of a voltage to a portion of the electrode element.

15. The system of claim 14, further comprising:
a supply element coupled to the controller to selectively provide the voltage to different segments included in a segmented focus electrode included in the electrode element.

16. The system of claim 14, wherein the downhole tool housing comprises one of a wireline tool housing or a drill string tool housing.

17. The system of claim 14, further comprising:
a mud sensor to provide a mud gradient measurement, to compensate for resistivity measurements provided by currents associated with the electrode element.

18. A method, comprising:
applying a voltage to a first electrode element to inject a first current into a borehole wall in a geological formation; and
receiving the first current at a downhole tool housing, wherein a stabilizer element is attached to the downhole tool housing, wherein the stabilizer element includes a first portion of a surface to contact the borehole wall, and a second portion of the surface to refrain from contacting the borehole wall, and wherein the first electrode element is attached to the second portion of the surface.

19. The method of claim 18, further comprising:
selectively applying the voltage to one or more arcuate segments included in the electrode element.

20. The method of claim 18, further comprising:
as a result of applying the voltage to the first electrode element, receiving a second current at a focus electrode portion of the electrode element.

21. The method of claim 18, further comprising:
developing a first image of the borehole wall using measurements of the first current;
developing a second image of the borehole wall using measurements of a second current injected into the borehole wall by applying the voltage to a second electrode element attached to a third portion of the surface, wherein an image resolution of the first image relative to an image resolution of the second image depends on a size relationship between the first electrode element and the second electrode element.

22. The method of claim 18, further comprising:
imaging the borehole wall using the first current; and
applying the voltage to a second electrode element attached to a third portion of the surface, to provide a backup current measurement value to a measurement of the first current.

23. The method of claim 18, further comprising:
switching between a transmission mode and a reception mode by coupling a voltage generator or a current receiver, respectively, to a primary focus electrode included in the first electrode element.

24. The method of claim 18, wherein the first electrode element includes a central measurement electrode, a primary focus electrode, and a segmented secondary focus electrode, wherein voltages applied to the primary and segmented secondary focus electrodes are substantially the same as the voltage applied to the central measurement electrode and a return electrode comprising a tool body, further comprising:
acquiring a first tool constant associated with the primary focus electrode operating in a transmission mode, wherein a voltage is applied to the primary focus electrode; and
acquiring a second tool constant associated with the primary focus electrode operating in a reception mode, wherein a return current is measured at the primary focus electrode.
